(19) United States
(12) Patent Application Publication
(10) Pub. No.: US 2005/0245126 A1
(43) Pub. Date: Nov. 3, 2005

(54) Wire clip integrated into lumbar support

(76) Inventors: Renato Colja, Windsor (CA); Stephen Certossi, Belle River (CA); Bogden Rencz, Windsor (CA)

Correspondence Address: HUSCH & EPPENBERGER, LLC, 190 CARONDELET PLAZA, SUITE 600, ST. LOUIS, MO, 63105-3441, US

(21) Appl. No.: 11/117,041

(22) Filed: Apr. 28, 2005

Related U.S. Application Data
(60) Provisional application No. 60/567,289, filed on Apr. 30, 2004.

(51) Int. Cl. H01R 13/66

(52) U.S. Cl. 439/535

(57) ABSTRACT

A clip (16,17,22) connects at least one wire (12,14) to a surface (10) and has first (18,19,24) and second (20,21,26) sidewalls, each having a first end and a second end. The first ends are secured to a surface to which it is desired to attach wires, and the second ends of the first and second sidewalls extend away from and are free from the surface. The second ends of the first and second sidewalls each have an arm extending toward the arm of the other sidewall, so as to define an unobstructed space between the first sidewall and the second sidewall in which to retain the at least one wire. The arms of the first and second sidewalls each have an outwardly facing surface and an inwardly facing surface formed on an end portion of the respective arm facing the space between the first sidewall and the second sidewall.

### CROSS-REFERENCE TO RELATED APPLICATIONS

This application relies upon and claims priority of pending U.S. Patent Application Ser. No. 60/567,289, Filed Apr. 30, 2004.

### BACKGROUND OF THE INVENTION

1. Field of the Invention

This invention relates generally to wire clipping or retention devices and, more particularly, to wire clipping systems for clipping lumbar supports to wire grids in a seat frame environment, for example, in a lumbar support mechanism.

2. Related Art

U.S. Pat. No. 5,769,491 discloses a wire clipping system for clipping lumbar supports to wire grids in a seat frame environment. This system utilizes a central tongue system disposed on a lumbar support wherein a central tongue is disposed between two sidewalls. The tongue prevents the entry and removal of two or more wires simultaneously. Rather, in the known system only one wire can be inserted at a time, and then a next wire is inserted in a deliberate separate step.

There is a need in the art for a wire clipping system for clipping lumbar supports to wire grids in a seat frame environment that does not utilize a central tongue system.

### SUMMARY OF THE INVENTION

It is in view of the above problems that the present invention was developed. The invention is a wire clipping system for clipping lumbar supports to wire grids in a seat frame environment. The described embodiments of the present wire clipping assembly invention permit attachment of a lumbar support basket to a plurality of wires or cables and avoid the use of a central tongue-in-clip system.

In a first embodiment, a staggered or alternating clipping system is employed. In this system, a first wire and then a second wire are alternately retained by clips positioned at staggered intervals on a “basket” of a lumbar support mechanism, or other convenient seat portion. This pattern of alternating retention of a wire may then be repeated. The distance between the nearest portions of opposing sidewalls of opposing retaining sidewalls is less than the diameter of each wire.

In a second embodiment, both the first wire and the second wire can be simultaneously inserted into a clip of the system and retained, but without the use of a central tongue in the retaining clips. The distance between the nearest portions of opposing retaining clip sidewalls is less than the diameter of either of the two wires.

In a third embodiment the retaining clips of the system include a duckbill detent mechanism to permit at least one wire to be easily inserted and effectively locked in a retained position upon the desired surface.

In keeping with the above features and goals, the present invention is, briefly, a clip which connects at least one wire to a surface and has first and second sidewalls, each having a first end and a second end. The first ends are secured to a surface to which it is desired to attach wires, and the second ends of the first and second sidewalls extend away from and are free from the surface. The second ends of the first and second sidewalls each have an arm extending toward the arm of the other sidewall, so as to define an unobstructed space between the first sidewall and the second sidewall in which to retain the at least one wire. The arms of the first and second sidewalls each have an outwardly facing surface and an inwardly facing surface formed on an end portion of the respective arm facing the space between the first sidewall and the second sidewall.

The invention is also, briefly, a wire retention assembly including a surface for retention thereto of at least two wires, and at least two wires retained on the surface. The assembly includes a plurality of clips secured to the surface for retaining the at least two wires on the surface so that the plurality of clips are arranged along the surface in at least two substantially parallel lines with clips being spaced apart along each line in staggered position relative to the clips on an adjacent line, to thereby permit the simultaneous retention on the same surface of at least two wires. Further, the clips of the assembly each have a first sidewall and a second sidewall, each of the first sidewall and the second sidewall having a first end and a second end, the first ends being secured to a surface to which it is desired to attach wires, and the second ends extending away from and being free from the surface. The second end of the first sidewall and the second end of the second sidewall each have an arm extending toward the arm of the other sidewall, so as to define an unobstructed space between the first sidewall and the second sidewall in which to retain at least one wire. The arm of the first sidewall and the arm of the second sidewall each have an outwardly facing surface and an inwardly facing surface formed on an end portion of the respective arm, facing the space between the first sidewall and the second sidewall.

The invention is also, briefly, a wire retention assembly having a surface for retention thereto of at least two wires, at least two wires retained on the surface; and a plurality of clips secured to the surface for retaining the at least two wires on the surface. The plurality of clips are arranged along the surface in at least two substantially parallel lines, with clips being spaced apart along each line in staggered position relative to the clips on an adjacent line, to thereby permit the simultaneous retention on the same surface of at least two wires. Further, the clips of the assembly each include a first sidewall and a second sidewall, having a first end and a second end. The first end of the first sidewall and the first end of the second are secured to a surface to which it is desired to attach wires, with the second end of the first sidewall and the second end of the second sidewall extending away from and being free from the surface. The second end of the first sidewall and the second end of the second sidewall each have an arm extending toward the arm of the other sidewall, so as to define an unobstructed space between the first sidewall and the second sidewall in which to retain at least one wire. Also, the arm of the first sidewall and the arm of the second sidewall each have an outwardly facing surface and an inwardly facing surface formed on an end portion of the respective arm, facing the space between the first sidewall and the second sidewall.

Further, the invention is, briefly, a method of attaching at least one wire to a surface of a lumbar support basket. The method includes providing a lumbar support basket with a surface to which it is desired to attach at least one wire; providing at least one wire; providing at least one clip for receiving and retaining the at least one wire, wherein such clips each have a first and second sidewall, each having a first end and a second end. The first end of the first sidewall and the first end of the second sidewall are secured to the surface of the lumbar support basket to which it is desired to attach wires, and the second end of the first sidewall and the second end of the second sidewall extend away from and are free from the surface. The second end of the first sidewall and the second end of the second sidewall each have an arm extending toward the arm of the other sidewall, so as to define an unobstructed space between the first sidewall and the second sidewall in which to retain the at least one wire. The arm of the first sidewall and the arm of the second sidewall each have an outwardly facing surface and an inwardly facing surface formed on an end portion of the respective arm to facilitate insertion of at least one wire between the first and second sidewalls. The method also includes pressing the at least one wire into the at least one clip between the corresponding arms of the first sidewall and the second sidewall and into the unobstructed space between the first sidewall and the second sidewall.

Further features and advantages of the present invention, as well as the structure and operation of various embodiments of the present invention, are described in detail below with reference to the accompanying drawings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 is a perspective view, partial broken away, of a lumbar support device, illustrating a first embodiment of the present invention utilizing an alternating or staggered wire clipping arrangement.

FIG. 2 is a schematic side view, enlarged, of a clip of FIG. 1.

FIG. 3 is a perspective view of a lumbar support device illustrating a second embodiment of the clipping system of the present invention utilizing a simultaneous clipping of two wires.

FIG. 4 is a schematic side view of a clip of FIG. 3, enlarged.

FIG. 5 is a schematic side view of a third embodiment of a clip of clipping system of the present invention, with an example of a deflected position shown in phantom.

### DETAILED DESCRIPTION OF THE PREFERRED EMBODIMENTS

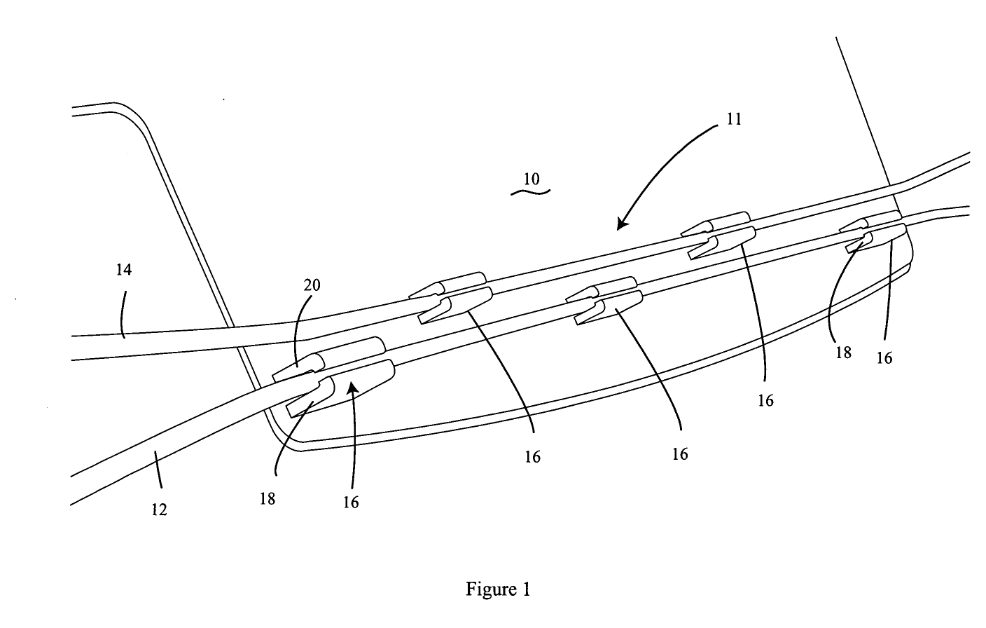

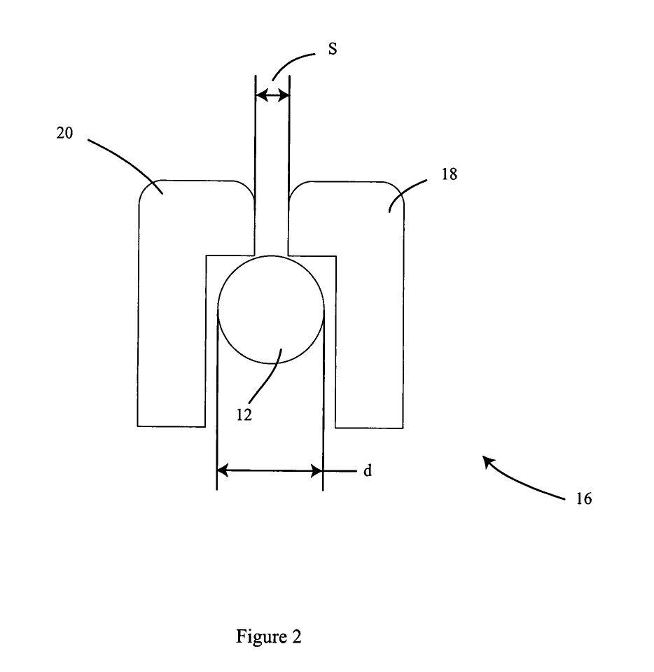

Referring to the accompanying drawings in which like reference numbers indicate like elements, FIGS. 1 and 2 illustrate a first embodiment of the present invention utilizing alternating or staggered wire clipping assembly. The individual clips of the assembly, in all embodiments described herein, can be fixed to a surface of a lumbar support basket or other desired surface by appropriate known mechanisms, for example by being molded integrally with the surface, being glued thereto, or being secured with known connectors. In the embodiments shown a surface 10 of a lumbar support basket is attached to first wire 12 and second wire 14 via a series of clips 16 which are disposed along the length of wires 12, 14 in alternating or staggered positions. That is, one clip 16 is disposed on retaining wire 12 and the next clip 16 is spaced apart, generally along the length of the wires, in an offset position, to retain wire 14. First and second wires 12, 14, respectively, are generally parallel to one another and substantially parallel to the generally planar surface 10 of a lumbar support basket, such as is widely used in the automobile seat industry.

Each clip 16 has a first opposing retaining sidewall 18 and a second opposing retaining sidewall 20. Each retaining sidewall 18, 20 has two opposed ends, one of which, the inward end, is rigidly attached or fixed to a surface 10. The opposite, outwardly extending free end of each sidewall has an arm, which extends generally toward the arm of the other sidewall. As shown in the drawings, the distance “s” between the nearest portions (the ends of the arms) of opposing retaining sidewall 18, 20 is less than the diameter “d” of each of first and second wires 12, 14. While wires 12, 14 can be of different diameters as compared to each other, it is preferred that they be general the same and in any case that the diameter of the wires will always be larger than the width of the space between the inwardly directed uppermost portions of sidewalls 18, 20, so as to not be inadvertently released from the clip.

In use, first wire 12 is retained by one clip 16, and then second wire 14 is retained by a next clip 16. This pattern of alternately clipping first wire 12 and then second wire 14 may be repeated as often as desired, depending upon the size of the surface to be connected to the wires, the size and strength of the wires and the size of the expected load, for example. As shown in FIG. 1, the pattern of alternately clipping the adjacent, spaced apart wires 12, 14 is preferably repeated two and a half times.

As best seen in FIG. 2, which shows the end of a wire 12 or 14 in a clipped position, the shape of the nearest portions of opposing retaining sidewalls 18, 20 are adapted, for example as shown with softly curved, inner corners on the generally lateral and inwardly disposed arms, to permit easy entry of either wire 12, 14 to a space between facing surfaces of the walls 18, 20. However, walls 18, 20 are also adapted to prevent the escape or removal of either wire 12, 14 once the wire 12, 14 has achieved a clipped position, as shown in FIG. 2. Opposing retaining sidewalls 18, 20 may flex inwardly during the entry of either wire 12, 14, but the right-angled, internal shape of opposing retaining sidewalls 18, 20 provide greater resistance to flexing outwardly to prevent the inadvertent release of either wire 12, 14 from the internal space of clip 16.

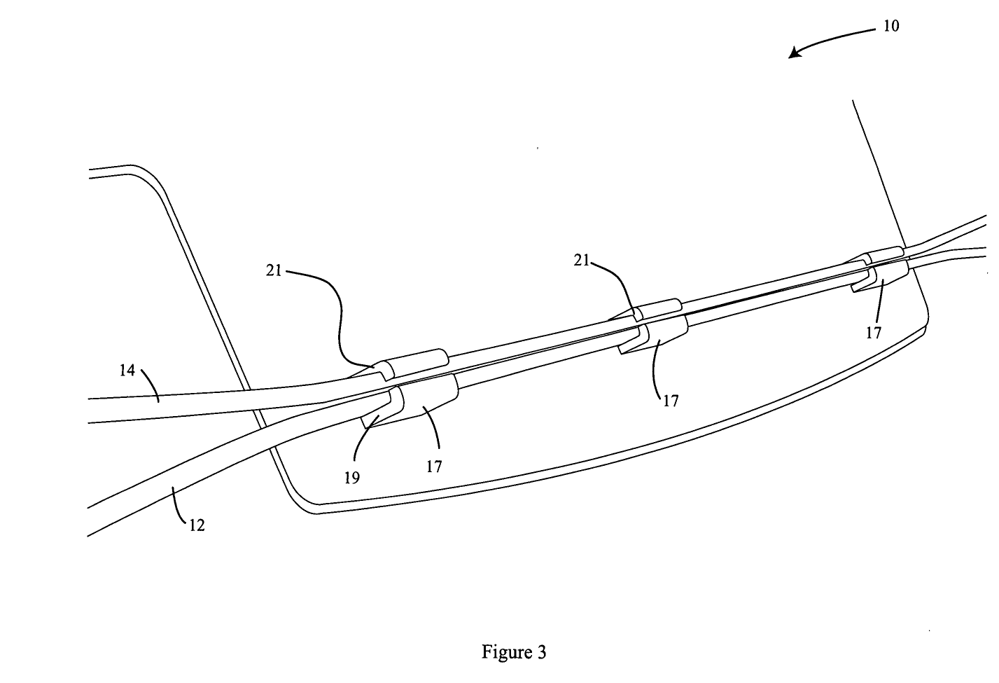

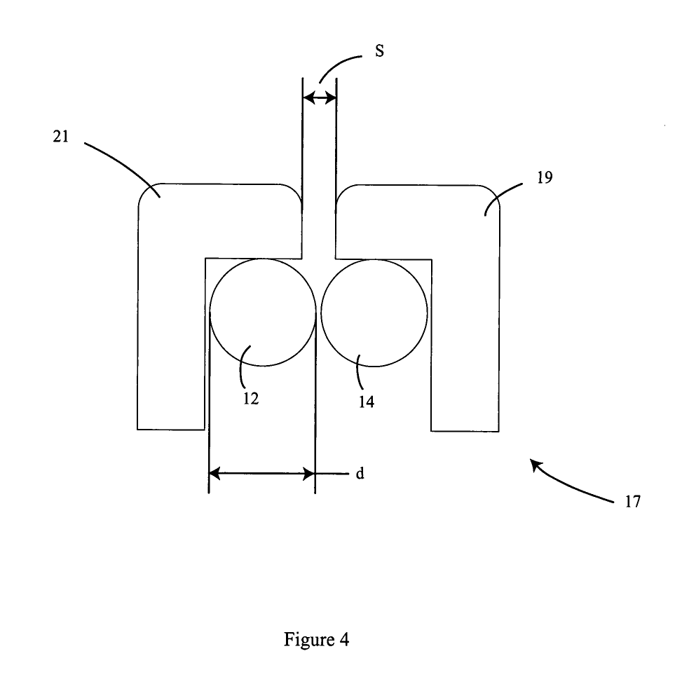

FIGS. 3 and 4 illustrate a second embodiment of the present invention utilizing a simultaneous clipping of both wires. Lumbar support basket 10 is attached to first wire 12 and second wire 14 via a series of clips 17. First and second wires 12, 14 are generally horizontally parallel along lumbar support basket 10. Each clip 17 has a first opposing retaining sidewall 18 and a second opposing retaining sidewall 20. As shown in the drawings, the distance “s” between the nearest portions of opposing retaining sidewalls 18, 20 is less than the diameter “d” of each of first and second wires 12, 14. In addition, the distance “s” between the nearest portions of opposing retaining sidewalls 18, 20 is less than the combined diameter “d” of first and second wires 12, 14.

As best seen in FIG. 4, which shows wires 12 or 14 in a clipped position, the shape of the nearest portions of opposing retaining sidewalls 18, 20, are adapted to permit easy entry of either wire, 12, 14, and then simultaneous retention of both wires 12 and 14, but is also adapted to prevent the escape or removal of either wire 12, 14 once the wires 12, 14 have achieved a clipped position. It can also be further seen that opposing retaining sidewalls 18, 20 may flex inward during the entry of either wire 12, 14, but that the shape of opposing retaining sidewalls 18, 20 are adapted to provide greater resistance to flexing outwardly to prevent the removal of either wire 12, 14.

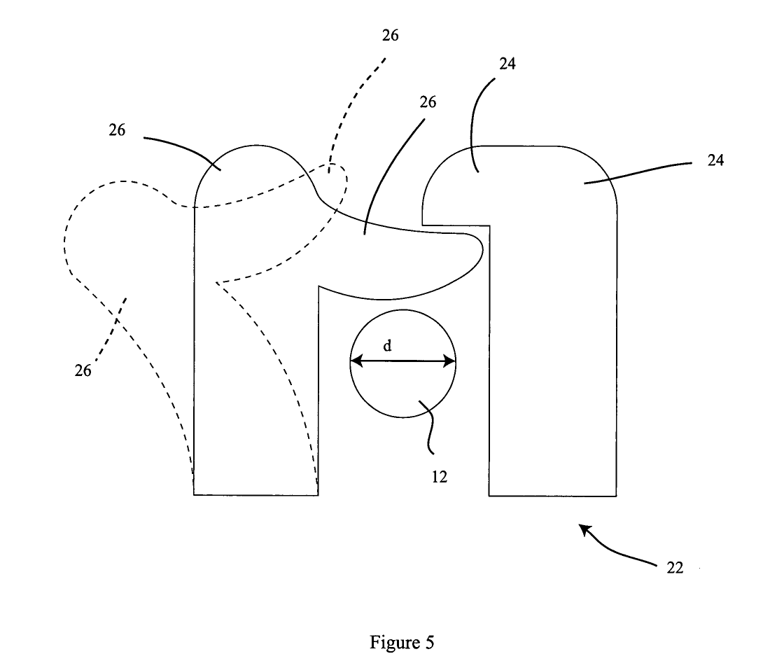

FIG. 5 illustrates a further useful embodiment of the clip of the present system. Clip 22 has opposed first and second upstanding sidewalls 24, 26, respectively, with corresponding arms 24′, 26′ at the upper, or outwardly extending free ends thereof. End 24′ is shaped similarly to the clips in the prior embodiments, with an inwardly extending arm having a rounded outside portion to permit sliding access to the space between sidewalls 24, 26, and an angled internal portion creating a “corner” facing into the clip internal space. By contrast, sidewall 26 has an upper end 26′ with an inwardly facing arm which takes a “duckbill” form extending downwardly and inwardly so that the innermost end of the arm or “bill” is securely disposed within the corner, beneath the angled overhang of facing end 24′.

The spacing between sidewalls 24, 26 is sufficiently wide as to be capable of retaining one or more wires, as however many may be desired. That is, depending upon the diameter of the wire, clips 22 are provided with sufficient distance between sidewalls 24, 26 to permit secure seating of the wires there between. To secure a wire, such as that indicated at 12, in clip 22, duckbill end 26′ of sidewall 26 is pressed slightly downwardly as sidewall 26, deflects and/or is pulled slightly outwardly, with pressure applied at the free end “head” end of sidewall 26, away from end 24′ of sidewall 24, so as to permit passage between the ends 24′, 26′ of the wire. If it is desired to remove a wire from clip 22, smoothly curved end of the “bill” of 26′ allows the wire to slide past it when the bill is pulled away, out from under end 24′, by applying pressure outwardly on the head of end 26′. Clip 22 can be used in the same versatile arrangements on a lumbar support basket as described in the previous embodiments and shown in FIGS. 1 and 3; i.e. staggered, to hold two or more wires approximately parallel, in separate sets of clips arranged in staggered formation along the wires, or by being sized large enough to hold at least two wires together within a plurality of clips set in collinear relationship to one another on a surface.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. For example, different geometric shapes may be used to adapt the contour of the nearest portions of opposing retaining sidewalls 18, 20, while retaining the concept of permitting the nearest portions of opposing retaining sidewalls to flex inwardly upon the entry of wires 12, 14, and yet provide greater resistance to the removal of wires 12, 14 from clip, 16, 18, 22. Thus, the breadth and scope of the present invention should not be limited by any of the above-described exemplary embodiments, but should be defined only in accordance with the following claims appended hereto and their equivalents.

1. A clip (16,17,22) for connecting at least one wire (12,14) to a surface (10), the clip comprising:
a first sidewall (18,19,24) and a second sidewall (20,21,26), each of the first sidewall and the second sidewall having a first end and a second end;
the first end of the first sidewall and the first end of the second sidewall being secured to a surface to which it is desired to attach wires, the second end of the first sidewall and the second end of the second sidewall extending away from and being free from the surface;
the second end of the first sidewall and the second end of the second sidewall each having an arm extending toward the arm of the other sidewall, so as to define an unobstructed space between the first sidewall and the second sidewall in which to retain the at least one wire; and
the arm of the first sidewall and the arm of the second sidewall each having an outwardly facing surface and an inwardly facing surface formed on an end portion of the respective arm facing the space between the first sidewall and the second sidewall.

2. The clip of claim 1, wherein the outwardly facing surface of at least one of the first sidewall arm and the second sidewall arm is formed with a curved shape to facilitate insertion of the at least one wire between the first and second sidewalls.

3. The clip of claim 2, wherein the outwardly facing surface of both the first sidewall arm and the second sidewall arm is formed with a curved shape.

4. The clip of claim 1, wherein the inwardly facing surface of at least one of the first sidewall arm and the second sidewall arm is formed with an angled shape to discourage removal of a wire from the space between the first sidewall and the second sidewall.

5. The clip of claim 4, wherein the inwardly facing surface of both of the first sidewall arm and the second sidewall arm is formed with an angled shape.

6. The clip of claim 3, wherein the inwardly facing surface of the first sidewall arm (24) is formed with an angled shape and the inwardly facing surface of the second sidewall arm (26) is formed of a curved shape.

7. The clip of claim 6, wherein the curved shape of the inwardly facing surface of the second sidewall arm (26′) is a duckbill shape disposed to face inwardly and with an end of the duckbill beneath and restricted in outward movement by the angled shape of the inwardly facing surface of the first sidewall arm (24′) to thereby discourage inadvertent release of a wire from within the space between the first sidewall and the second sidewall of the clip (22).

8. The clip of claim 1, wherein a distance “s” between nearest portions of the first sidewall arm and the second sidewall arm is less than a diameter “d” of a wire to be retained by the clip.

9. A wire retention assembly comprising:
a surface for retention thereto of at least two wires;
at least two wires retained on the surface; and
a plurality of clips secured to the surface for retaining the at least two wires on the surface;
wherein the plurality of clips are arranged along the surface in at least two substantially parallel lines, with clips being spaced apart along each line in staggered position relative to the clips on an adjacent line, to thereby permit the simultaneous retention on the same surface of at least two wires; and further
wherein the clips of the assembly each comprise:
a first sidewall (18,19,24) and a second sidewall (20,21,26), each of the first sidewall and the second sidewall having a first end and a second end;
the first end of the first sidewall and the first end of the second sidewall being secured to a surface to which it is desired to attach wires, the second end of the first sidewall and the second end of the second sidewall extending away from and being free from the surface;
the second end of the first sidewall and the second end of the second sidewall each having an arm extending toward the arm of the other sidewall, so as to define an unobstructed space between the first sidewall and the second sidewall in which to retain at least one wire; and
the arm of the first sidewall and the arm of the second sidewall each having an outwardly facing surface and an inwardly facing surface formed on an end portion of the respective arm, facing the space between the first sidewall and the second sidewall.

10. The assembly of claim 9, wherein a distance “s” between nearest portions of any clip first sidewall arm and the corresponding clip second sidewall arm is less than a diameter “d” of a wire to be retained by the plurality of clips.

11. A wire retention assembly comprising:
a surface (10) for retention thereto of at least two wires;
at least two wires (12, 14) retained on the surface (10) within a single line of clips; and
a plurality of clips (17, 22) secured to the surface for retaining the at least two wires on the surface;
wherein the plurality of clips are arranged spaced apart along the surface in a single line; and
further wherein
the clips (17, 22) of the assembly comprise:
a first sidewall (19,24) and a second sidewall (21,26), each of the first sidewall and the second sidewall having a first end and a second end;
the first end of the first sidewall and the first end of the second sidewall being secured to a surface to which it is desired to attach wires, the second end of the first sidewall and the second end of the second sidewall extending away and being free from the surface;
the second end of the first sidewall and the second end of the second sidewall each having an arm extending toward the arm of the other sidewall, so as to define an unobstructed space between the first sidewall and the second sidewall of sufficient width in which to retain the at least two wires; and
the arm of the first sidewall and the arm of the second sidewall each having an outwardly facing surface and an inwardly facing surface formed on the end portion of the respective arm facing the space between the first sidewall and the second sidewall.

12. The assembly of claim 11, wherein the outwardly facing surface of both the first sidewall arm and the second sidewall arm is formed with a curved shape.

13. The assembly of claim 11, wherein the inwardly facing surface of both of the first sidewall arm and the second sidewall arm is formed with an angled shape.

14. The assembly of claim 11, wherein the inwardly facing surface of the first sidewall arm (24) is formed with an angled shape and the inwardly facing surface of the second sidewall arm (26) is formed of a curved shape.

15. A method of attaching at least one wire to a surface of a lumbar support basket comprising:
providing a lumbar support basket with a surface to which it is desired to attach at least one wire;
providing at least one wire;
providing at least one clip for receiving and retaining the at least one wire, wherein such clips each have a first sidewall (18,19,24) and a second sidewall (20,21,26), each of the first sidewall and the second sidewall having a first end and a second end, the first end of the first sidewall and the first end of the second sidewall being secured to the surface of the lumbar support basket to which it is desired to attach wires, the second end of the first sidewall and the second end of the second sidewall extending away from and being free from the surface, the second end of the first sidewall and the second end of the second sidewall each having an arm extending toward the arm of the other sidewall, so as to define an unobstructed space between the first sidewall and the second sidewall in which to retain the at least one wire; and the arm of the first sidewall and the arm of the second sidewall each having an outwardly facing surface and an inwardly facing surface formed on an end portion of the respective arm to facilitate insertion of at least one wire between the first and second sidewalls; and
pressing the at least one wire into the at least one clip between the corresponding arms of the first sidewall and the second sidewall and into the unobstructed space between the first sidewall and the second sidewall.

16. The method of claim 15, wherein the at least one wire is at least two wires and the at least one clip is a plurality of clips, and further comprising the step of:
providing the plurality of clips in staggered arrangement on the surface in at least two spaced apart and substantially parallel lines, so that the at least two wires are securely retained side-by side to the surface.

17. The method of claim 15, wherein the at least one wire is at least two wires and the at least one clip is a plurality of clips, and further comprising providing such plurality of clips wherein the outwardly facing surfaces of the first sidewall arm and the second sidewall arm of the clips are formed with a curved shape, thereby facilitating insertion of at least one wire between the first and second sidewalls.

18. The method of claim 15, wherein the at least one wire is at least two wires (12, 14) and the at least one clip (16, 17, or 22) is a plurality of clips, and further comprising providing such plurality of clips wherein the inwardly facing surface of at least one of the first sidewall (18, 19, 24) arm and the second sidewall (20, 21) arm of the clips are formed with an angled shape, thereby discouraging inadvertent removal of at least one wire from the space between the first sidewall and the second sidewall.

19. The method of claim 17, and further comprising providing such plurality of clips (22) wherein the curved shaped of the inwardly facing surface of the second sidewall arm (26′) of each clip of the plurality of clips is a duckbill shape disposed to face inwardly, with an end of the duckbill beneath and restricted in outward movement by the angled shape of the inwardly facing surface of the first sidewall arm (24′) to thereby discourage inadvertent release of the at least one wire (12, 14) from within the unobstructed space between the first sidewall and the second sidewall.

20. A method of clipping wires to a lumbar support comprising:
clipping a first wire to a first clip on one end of said lumbar support;
clipping a second wire to a second clip on said one end of said lumbar support, and parallel to said first wire.

21. A clip disposed on a lumbar support comprising:
first and second opposing retaining sidewalls defining said clip, each opposing retaining sidewall having a portion nearest the other opposing retaining sidewall which defines a space “s” between said opposing retaining sidewalls,
a first wire having a diameter “d”;
wherein said space “s” is less than said diameter “d” such that said first wire may be retained within said clip and thereby fixed to said lumbar support.

22. A clip disposed on a lumbar support comprising:
first and second opposing retaining sidewalls defining said clip, each opposing retaining sidewall having a portion nearest the other opposing retaining sidewall which defines a space “s” between said opposing retaining sidewalls,
a first wire having a diameter “d”;
a second wire having a diameter “d”;
wherein said space “s” is less than two times diameter “d” such that said first wire and said second wire may be simultaneously retained within said clip and thereby fixed to said lumbar support.
